(19) United States
(12) Patent Application Publication
(10) Pub. No.: US 2026/0006088 A1
(43) Pub. Date: Jan. 1, 2026

(54) Systems and Methods for Providing a Push-To-Talk Session Using Web Real-Time Communication

(71) Applicant: ZABRA TECHNOLOGIES CORPORATION, Lincolnshire, IL (US)

(72) Inventors: David Kreider, Elk River, MN (US); Iouri Tarsounov, Lakewood Ranch, FL (US); Win Nu Nu Win, Lincolnshire, IL (US); Amit Shah, Hoffman Estates, IL (US); Vladysiav Kovai, Orlando, FL (US)

(21) Appl. No.: 18/756,966

(22) Filed: Jun. 27, 2024

(51) Int. Cl. H04L 65/4061; H04L 65/1093; H04L 65/1108; H04L 65/4053

(52) U.S. Cl. CPC H04L 65/4061; H04L 65/1093; H04L 65/1108; H04L 65/4053

(57) ABSTRACT

Devices, systems and methods for providing a push-to-talk (PTT) session including half-duplex communications using a Web Real-Time Communication (WebRTC) protocol are provided. An example method may receive, from a computing device of a PTT session initiator, a session request to initiate the PTT session, the session request including information of additional PTT session participants. Responsive to receiving the session request, (a) initiating the PTT session including the PTT session initiator as an initial PTT session participant, (b) providing the PTT session initiator control of the PTT session, (c) generating an invite request to join the PTT session, and (d) transmitting the invite request to computing devices of the additional PTT session participants. Responsive to an acceptance of the invite request from additional PTT session participants, providing the additional PTT session participants access to the PTT session, and designating the additional PTT session participants as receivers of the communications.

### BACKGROUND

The Web Real-Time Communication (WebRTC) protocol provides a powerful, flexible, and cost-effective solution for incorporating real-time communication capabilities into applications (e.g., web applications, mobile applications, etc.) without the need for added plugins or software. In addition to being operating system and browser agnostic, the WebRTC protocol also provides benefits including low latency, built-in security features (e.g., end-to-end encryption), and support for audio, video, and data transmissions, among other advantages. Conventional push-to-talk (PTT) communications use a half-duplex protocol allowing one PTT session participant at a time (e.g., the “speaker”) to transmit audio communications to other PTT session participants. WebRTC does not support half-duplex communications, preventing conventional PTT systems from taking advantage of the many benefits the WebRTC protocol provides.

Accordingly, there is a need for systems and methods that provide half-duplex PTT communications using the WebRTC protocol.

### SUMMARY

In an embodiment, the present disclosure discloses a method for providing a push-to-talk (PTT) session including half-duplex communications using a Web Real-Time Communication (WebRTC) protocol. The method may include (i) receiving, from a computing device of a PTT session initiator, a session request to initiate the PTT session including the half-duplex communications using the WebRTC protocol, wherein the session request includes information of one or more additional PTT session participants; (ii) responsive to receiving the session request, (a) initiating the PTT session including the PTT session initiator as an initial PTT session participant, (b) providing the PTT session initiator control of the PTT session by designating the PTT session initiator as a transmitter of communications of the PTT session able to transmit the communications to all other PTT session participants, (c) generating an invite request to join the PTT session, and (d) transmitting the invite request to one or more computing devices of the respective one or more additional PTT session participants; and (iii) responsive to receiving a response accepting the invite request from at least one additional PTT session participant of the one or more additional PTT session participants via a respective at least one computing device, providing the at least one additional PTT session participant access to the PTT session, and designating the at least one additional PTT session participant as a receiver of the communications unable to transmit any communications to any PTT session participants.

In a variation of the embodiment, the method may include (i) receiving, from the computing device of a PTT session participant of a plurality of PTT session participants of the PTT session, a control request to provide the PTT session participant associated with the control request control of the PTT session by designating the PTT session participant associated with the control request as the transmitter of communications of the PTT session, and designating remaining PTT session participants as receivers of the communications unable to transmit any communications to any PTT session participants; (ii) approving the control request when the PTT session does not include the transmitter of the communications when the control request is received; and (iii) denying the control request when the PTT session includes the transmitter of communications when the control request is received.

In another variation of the embodiment, one or more of a request or a response associated with the PTT session is transmitted using a Websocket protocol.

In yet another variation of the embodiment, the WebRTC protocol includes Secure Real-Time Transport.

In still yet another variation of the embodiment, the communications include audio.

In another variation of the embodiment, the method may include determining the at least one additional PTT session participant is unavailable to join the PTT session; and responsive to determining the at least one additional PTT session participant is unavailable, one or more of: (i) refraining from transmitting the invite request to the at least one computing device of the respective at least one additional PTT session participant, (ii) transmitting the invite request to the at least one computing device of the respective at least one additional PTT session participant responsive to determining the at least one additional PTT session participant becomes available to join the PTT session, (iii) providing a notification to the computing device of the PTT session initiator indicating the at least one additional PTT session participant is unavailable, or (iv) terminating the PTT session.

In yet another variation of the embodiment, the method may include designating the transmitter of the communications as a receiver of the communications based upon one or more of: (i) expiration of a timeout period during which the transmitter does not provide the communications, (ii) receiving a relinquish request from the computing device of the transmitter to relinquish a designation as the transmitter; or (iii) receiving the control request to control the PTT session from the computing device of a receiver of the communications of the PTT session.

In still yet another variation of the embodiment, the PTT session further includes one or more of full-duplex video communications or file sharing.

In another variation of the embodiment, the method may include terminating the PTT session based on one or more of expiration of a timeout period during which the transmitter does not provide the communications, or all PTT session participants leaving the PTT session.

In another embodiment, the present disclosure discloses a system for providing a PTT session including half-duplex communications using a WebRTC protocol. The system may include one or more processors; and a memory storing instructions that, when executed by the one or more processors, may cause the system to: (i) receive, from a computing device of a PTT session initiator, a session request to initiate the PTT session including the half-duplex communications using the WebRTC protocol, wherein the session request includes information of one or more additional PTT session participants; (ii) responsive to receiving the session request, (a) initiate the PTT session including the PTT session initiator as an initial PTT session participant, (b) provide the PTT session initiator control of the PTT session by designating the PTT session initiator as a transmitter of communications of the PTT session able to transmit the communications to all other PTT session participants, (c) generate an invite request to join the PTT session, and (d) transmit the invite request to one or more computing devices of the respective one or more additional PTT session participants; and (iii) responsive to receiving a response accepting the invite request from at least one additional PTT session participant of the one or more additional PTT session participants via a respective at least one computing device, provide the at least one additional PTT session participant access to the PTT session, and designate the at least one additional PTT session participant as a receiver of the communications unable to transmit any communications to any PTT session participants.

In yet another embodiment, the present disclosure discloses a tangible machine-readable medium comprising instructions that, when executed by one or more processors, cause a machine to at least: (i) receive, from a computing device of a PTT session initiator, a session request to initiate a PTT session including half-duplex communications using a WebRTC protocol, wherein the session request includes information of one or more additional PTT session participants; (ii) responsive to receiving the session request, (a) initiate the PTT session including the PTT session initiator as an initial PTT session participant, (b) provide the PTT session initiator control of the PTT session by designating the PTT session initiator as a transmitter of communications of the PTT session able to transmit the communications to all other PTT session participants, (c) generate an invite request to join the PTT session, and (d) transmit the invite request to one or more computing devices of the respective one or more additional PTT session participants; and (iii) responsive to receiving a response accepting the invite request from at least one additional PTT session participant of the one or more additional PTT session participants via a respective at least one computing device, provide the at least one additional PTT session participant access to the PTT session, and designate the at least one additional PTT session participant as a receiver of the communications unable to transmit any communications to any PTT session participants.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a block diagram of an example computing environment for providing push-to-talk session participants control of a push-to-talk session, according to some embodiments.

FIG. 2A depicts an example signal diagram for providing a push-to-talk session including half-duplex communications using a Web Real-Time Communication protocol, according to some embodiments.

FIG. 2B depicts a first example user interface for initiating a push-to-talk session including half-duplex communications using the Web Real-Time Communication protocol, according to some embodiments.

FIG. 2C depicts a second example user interface for accepting a push-to-talk session invite request to join a push-to-talk session, according to some embodiments.

FIG. 2D depicts a third example user interface during the push-to-talk session, according to some embodiments.

FIG. 3 depicts a flow diagram of an example method for providing a push-to-talk session including half-duplex communications using the Web Real-Time Communication protocol, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The disclosed systems and methods provide a push-to-talk (PTT) session including half-duplex communications using a Web Real-Time Communication (WebRTC) protocol. The term “PTT session” may be referred to interchangeably herein as a “PTT call,” “a session,” “a call,” and the like. Further, terms “speaker,” “transmitter of communications,” “transmitter,” “controller of the floor,” and the like may be used interchangeably. Similarly, the terms “listener,” “receiver of communications,” “receiver,” and the like may be used interchangeably herein. Moreover, the Web Real-Time Communication protocol may at times simply be referred to as WebRTC.

A PTT session may include a communications environment that supports half-duplex PTT communications of computing devices. To provide the PTT session using WebRTC, a server or other suitable computing device (generally hereinafter server) may receive a session request to initiate the PTT session. A computing device of a PTT session initiator may generate and transmit the session request to the server. The session request may include information of one or more additional PTT session participants other than the session initiator, such as additional PTT session participants the session initiator selects to be part of the PTT session. In response to receiving the session request, the server may initiate the PTT session, and include the PTT session initiator in the PTT session as an initial PTT session participant. The server may also designate the PTT session initiator as a transmitter of communications (e.g., audio communications) providing the session initiator the exclusive ability to transmit the communications to all other PTT session participants according to half-duplex communication protocols. The server may generate an invite request to join the PTT session and transmit the invite request to one or more computing devices of the respective one or more additional PTT session participants indicated in the session request. The invite request may enable the additional PTT session participants to join the PTT session via their respective user devices. Responsive to receiving a response accepting the invite request from the computing device(s) of at least one additional PTT session participant, the server may provide the respective additional PTT session participant(s) access to the PTT session, including designating each additional PTT session participant as a receiver of the transmitter's communications. The PTT session participants designated as receivers of the communications are unable to transmit any communications to any other PTT session.

Configuring the PTT communication environment to have one speaker/transmitter of communications having control of the floor during the PTT session, with the remaining PTT session participants being designated as listeners/receivers of the speaker's communications as described above provides half-duplex communications using the WebRTC protocol, unlike conventional PTT systems. Accordingly, WebRTC improves the technical field of PTT communications by providing the aforementioned benefits and advantages otherwise unavailable via conventional PTT systems, including a protocol that is operating system and browser agnostic, provides real-time communications (e.g., via web browsers, mobile applications, etc.) without the need for plugins or additional software, includes always-on encryption (e.g., via the Secure RTP protocol of at least some embodiments of the disclosed systems and methods), has low latency, and is interoperable with many existing communication systems and/or protocols (e.g., Session Initiation Protocol (SIP), Jingle, Extensible Messaging and Presence Protocol (XMPP), Publicly Switched Telephone Network (PSTN)). Moreover, in at least some embodiments, WebRTC allows the PTT session to support full-duplex video communications and/or file sharing for the PTT session participants, further improving the technical field of PTT communications and/or PTT systems and methods.

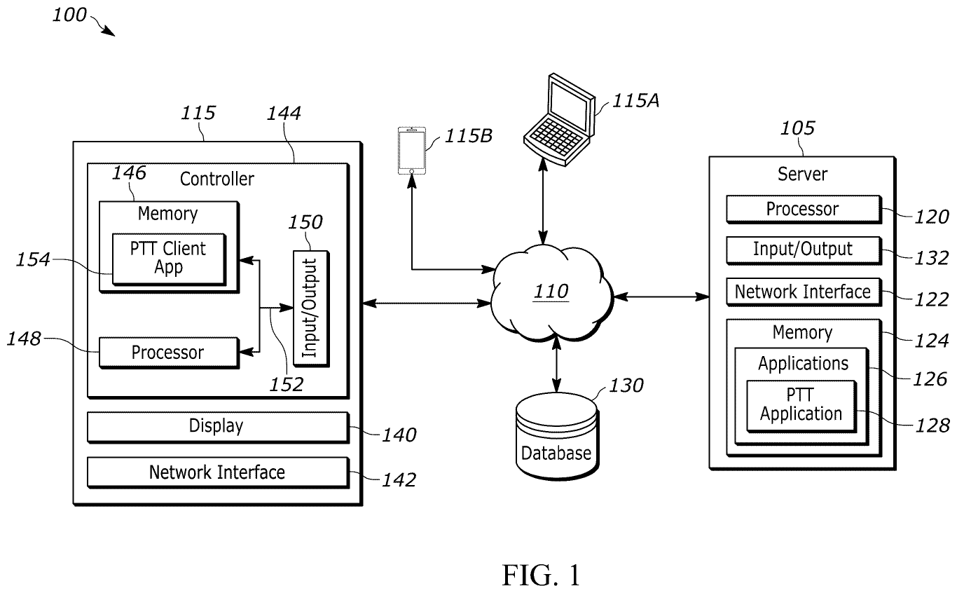

FIG. 1 depicts an example computing environment for providing a PTT session including half-duplex communications using a WebRTC protocol, according to some embodiments. The example computing environment 100 may include a server 105, a network 110, a database 130, and user devices 115. Although FIG. 1 depicts certain devices, components, equipment, and devices, it should be appreciated that the computing environment 100 may include additional, fewer, and/or alternate components, and may be configured to perform additional, fewer, or alternate actions, including components and/or actions described herein. For instance, information described as being stored in the database 130 may be stored in memory 124, and therefore the database 130 may be omitted. Moreover, it should be appreciated that additional and/or alternative connections between components depicted in FIG. 1 may be implemented. As one example, the server 105 and the database 130 may be connected via a direct communication link (not shown in FIG. 1) instead of, or in addition to, via the network 110.

The server 105 may perform at least some of the functionalities and techniques disclosed herein, such as providing half-duplex PTT communications using WebRTC. The server 105 may include one server, or multiple servers that are co-located and/or remotely distributed. The server 105 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The example computing environment 100 may include a network 110 comprising any suitable network or combination of networks, such as a local area network (LAN), a wide area network (WAN), the Internet, or a combination thereof. For example, the network 110 may include a wireless cellular network (e.g., 4G, 5G, 6G, etc.). Generally, the network 110 may enable bidirectional communication between the server 105 and/or the user devices 115. In some embodiments, the network 110 comprises a cellular base station, such as cell tower(s), communicating to the one or more other components of the computing environment 100 via wired/wireless communications based on any one or more of various mobile phone standards, including NMT, GSM, CDMA, UMTS, LTE, 5G, 6G, or the like. Additionally or alternatively, the network 110 may comprise one or more routers, wireless switches, and/or other such wireless nodes communicating with the components of the computing environment 100 via wired and/or wireless communications based on any one or more of various communications standards, including by non-limiting example, IEEE 802.11a/ac/ax/b/c/g/n (Wi-Fi), Bluetooth, and/or the like.

The example server 105 may include at least one processor 120. The processor 120 may include one or more processors, such as central processing units (CPUs), graphics processing units (GPUs), and/or any other suitable processor. The processor 120 may be communicatively coupled to the memory 124 via a computer bus (not depicted) to create, read, update, transmit, delete, or otherwise access or interact with the data, data packets, or otherwise electronic signals to and from the processor 120 and the memory 124, e.g., to implement or perform the machine-readable instructions, methods, processes, elements, or limitations, as illustrated, depicted, or described for the various flowcharts, illustrations, diagrams, figures, and/or other disclosure herein. The processor 120 may interface with the memory 124 via a computer bus to execute an operating system and/or computing instructions stored in the memory 124, and/or to access other services/components/etc. For example, the processor 120 may interface with the memory 124 via the computer bus to create, read, update, delete, or otherwise access or interact with the data stored in the memory 124 and/or the database 130.

The server 105 may include a network interface 122 which allows the server 105 to communicate over the network 110 (e.g., with other servers 105, the user devices 115, the database 130) via any suitable wired and/or wireless connection, e.g., using any suitable network interface controller(s) of the network interface 122. The network interface 122 may include one or more transceivers (e.g., wireless WAN (WWAN), wireless LAN (WLAN), and/or wireless personal area network (WPAN) transceivers) functioning in accordance with IEEE reference standards, 3GPP reference standards, and/or other reference standards that may be used in receipt and transmission of data via external/network ports of the server 105 connected to the network 110.

The memory 124 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc. The memory 124 may store machine-readable instructions executable by the processor 120, including the instructions of one or more application(s) 126. The memory 124 may also store an operating system (e.g., Microsoft Windows, Linux, UNIX, etc.) capable of facilitating the functionalities, applications, methods, or other software of the applications 126 as discussed herein.

In the example embodiment of FIG. 1, the applications 126 include a PTT application 128 providing various functionalities described in further detail below, which may include functionalities associated with PTT communications, such as creating and/or supporting a half-duplex PTT session using WebRTC.

The server 105 may include, and/or have access to (e.g., via network 110), the database 130. The database 130 may include one or more databases that are co-located or remotely distributed. The database 130 may be or include a relational database, such as Oracle, DB2, MySQL, a NoSQL based database, such as MongoDB, or another suitable database. The database 130 may store data and/or datasets including one or more types of data, records, files, etc., such as data associated with PTT session participants (user profiles, contact information), files shared during the PTT session, PTT session logs, and/or other suitable data.

The server 105 may include an input/output (I/O) module 132, comprising a set of computer-executable instructions implementing communication functions. The I/O module 132 may further include or implement an operator interface configured to present information to an administrator or operator and/or receive inputs from the administrator and/or operator. An operator interface may provide a display screen. The I/O module 132 may facilitate I/O components (e.g., ports, capacitive or resistive touch sensitive input panels, keys, buttons, lights, LEDs), which may be directly or indirectly accessible via, or attached to, server 105.

The computing environment 100 may include one or more user devices 115. The user devices 115 may be in communication (e.g., via the network 110) with the server 105, for example to access and/or participate in a PTT session. The user devices 115 may comprise one or more computers and/or multiple, redundant, or replicated client computers accessed by one or more users. The user devices 115 may include one or more computing devices (e.g., a desktop computer, a laptop computer 115A, a terminal), mobile devices (e.g., a smartphone 115B, a tablet), wearables (e.g., a smartwatch, an augmented reality/virtual reality headset), and/or other suitable electronic device. The user device 115 may include a display 140, a network interface 142 (e.g., the network interface 122), and a controller 144. The controller 144 may include a memory 146 (e.g., the memory 124), a processor 148 (e.g., the processor 120), and an I/O module 150 (e.g., the I/O module 132), all of which may be interconnected via an address/data bus 152.

The memory 146 may include an operating system, a plurality of software applications and/or routines, among other things. One of the plurality of applications may be a native application and/or web browser that may be implemented as a series of machine-readable instructions for receiving, interpreting, and/or displaying application screens or web page information from the server 105 while also receiving inputs from the user. The memory 146 may include data such as application data, routine data for the routines, and/or other data necessary to interact with the server 105 via the network 110.

The memory 146 may include a PTT client application 154, e.g., to provide one or more functionalities associated with a PTT session and/or PTT communications, among others, such as initiating the PTT session, participating in the PTT session, etc. In at least some embodiments, the PTT application 128 may provide at least some of the functionality of the PTT client application 154, for example the server 105 may execute the PTT application 128 to host a PTT session, and the user device 115 may communicatively couple to the server 105 (e.g., via the network 110) to participate in the PTT session using the PTT client application 154.

In some embodiments, the controller 144 may also include, or otherwise be communicatively connected to, other data storage mechanisms (e.g., one or more hard disk drives, optical storage drives, solid state storage devices, etc.) that reside within the user device 115.

In at least some embodiments, a user of a user device 115 may initiate a PTT session, e.g., to conduct a PTT call with other call participants using WebRTC. To initiate the call, the call initiator may generate a session request via their user device 115. For example, the call initiator via their user device 115 (referred to at times as a computing device) may execute the PTT client application 154, select one or more participants (e.g., from a contact list in the PTT client application 154) to invite to join the session, and generate the session request to initiate the session (e.g., by activating a hardware button on the user device or a virtual button of the PTT client application 154 to start the PTT session, etc.). The user device 115 may transmit the session request that includes information of the selected session participants (e.g., name, device identifier, etc.) to the server 105 via the network 110. In at least some embodiments, the session request, or other requests and/or responses transmitted between devices and/or components of the computing environment 100, may use a Websocket protocol.

In response to receiving the request, the server 105 may initiate the PTT session (e.g., using the PTT application 128), for example by establishing an electronic environment for communications between PTT session participants. The server 105 may include the session initiator as the initial session participant of the PTT session. The server 105 may provide the PTT session initiator control of the PTT session by designating the PTT session initiator as a transmitter of communications. The transmitter of communications of the PTT session may be able to transmit the communications (e.g., audio) from their user device 115 to the user devices 115 of the other PTT session participants in a half-duplex manner, such that the other PTT session participants are able to receive the communications (e.g., receive the audio transmitted by the transmitter), but unable to send transmissions to other participants of the PTT session.

The server 105 may generate an invite request to join the PTT session, and transmit the invite request to the computing devices 115 of the one or more additional PTT session participants indicated in the session request. The additional PTT session participants may, for example, receive a notification via their user device 115 (e.g., ringing of the user device 115 indicating an incoming call, a pop-up notification from the PTT client application) indicating they are invited to join the PTT session. The invited additional PTT session participant may accept the PTT invite request (e.g., via the PTT client application 154, by answering the call), which may cause their respective user device 115 to generate a response accepting the invite request, and transmit the response accepting the invite request to the server 105 via the network 110.

Responsive to receiving the response accepting the invite request, the server 105 may provide the corresponding additional PTT session participant access to the PTT session. The server 105 may designate the additional PTT session participants joining the PTT session as receivers of the communications transmitted by the session initiator, thereby establishing half-duplex communications in which only one session participant (e.g., the transmitter) at a time is able to transmit communications. In at least some embodiments, rather than automatically designating the session initiator as the transmitter, any one of the PTT session participants may be designated by the server 105 as the transmitter. In at least some embodiments, the server 105 may receive a control request requesting control of the floor as the transmitter from the user device 115 of the PTT session participant. If no other PTT session participant is designated as the transmitter, the server 205 may approve the control request.

In at least some embodiments, an additional PTT session participant (e.g., indicated in the session request) may be unavailable to join the PTT session. In at least some aspects, the additional PTT session participant may be a participant in another PTT session, may have their user device in a “do not disturb” mode, or other suitable reason. The server 105, the session initiator's user device, and/or other suitable device of the computing environment 100 may determine, and/or have an indication of, the unavailability of the unavailable additional PTT session participant. For example, the user device 115 of the unavailable additional PTT session participant may provide information to other user devices of the computing environment 100 indicating their unavailable status (e.g., via the PTT client application 154), and/or the server 105 may receive (e.g., via the PTT application 128) information indicating the unavailability of the unavailable additional PTT session participant. In response to determining the unavailability of the additional PTT session participant, the server 105 may perform one or more actions. In at least some aspects, the server 105 may refrain from transmitting the invite request to the user device 115 of the unavailable additional PTT session participant. In at least other aspects, the server 105 may transmit the invite request to the computing device 115 of the unavailable additional PTT session participant in response to determining the unavailable additional PTT session participant becomes available (e.g., via information provided by the PTT client application 154 and/or received by the PTT application 128). In yet other aspects, the server 105 may provide a notification to the computing device 115 of the PTT session initiator (e.g., via the PTT client application 154) indicating the unavailability of the additional PTT session participant. In still other aspects, the server 105 may terminate the PTT session (e.g., when the unavailable additional PTT session participant is the only additional PTT session participant the session initiator requests to participate in the PTT session).

The transmitter may transmit communications (e.g., audio) using WebRTC to the remaining participants of the PTT session designated as receivers, which may include Secure RTP (SRTP). For example, the transmitter's user device 115 may transmit the communications using WebRTC to the server 105 via the network 110, and the server 105 may transmit the communications using WebRTC via the network 110 to the remaining PTT session participant receivers.

During the PTT session, the transmitter may be redesignated from the transmitter to the receiver by the server 105 (e.g., the PTT client application 154) and/or other suitable device or component of the computing environment 100. In at least some aspects, the transmitter may be designated as the receiver upon the expiration of a timeout period during which the transmitter does not provide communications. In at least other aspects, the server 105 may receive a relinquish request from the computing device 115 of the transmitter to relinquish the designation as the transmitter, and as a result redesignate the transmitter as the receiver. In yet other aspects, the server 105 may receive a control request to control the PTT session from the computing device 115 of a receiver, and in response may redesignate the current transmitter as a receiver, and redesignate the receiver associated with the control request as the transmitter.

In some embodiments, the server 105 may terminate the PTT session. In at least some aspects, all PTT session participants may leave the PTT session (e.g., via the PTT client application 154 on their respective user devices 115), causing the PTT session to terminate. In at least other aspects, the PTT session may terminate upon expiration of a timeout period during which the transmitter does not provide the communications (e.g., when the transmitter has nothing else to say to the participants during the session, and none of the other session participants request control of the session to become the transmitter).

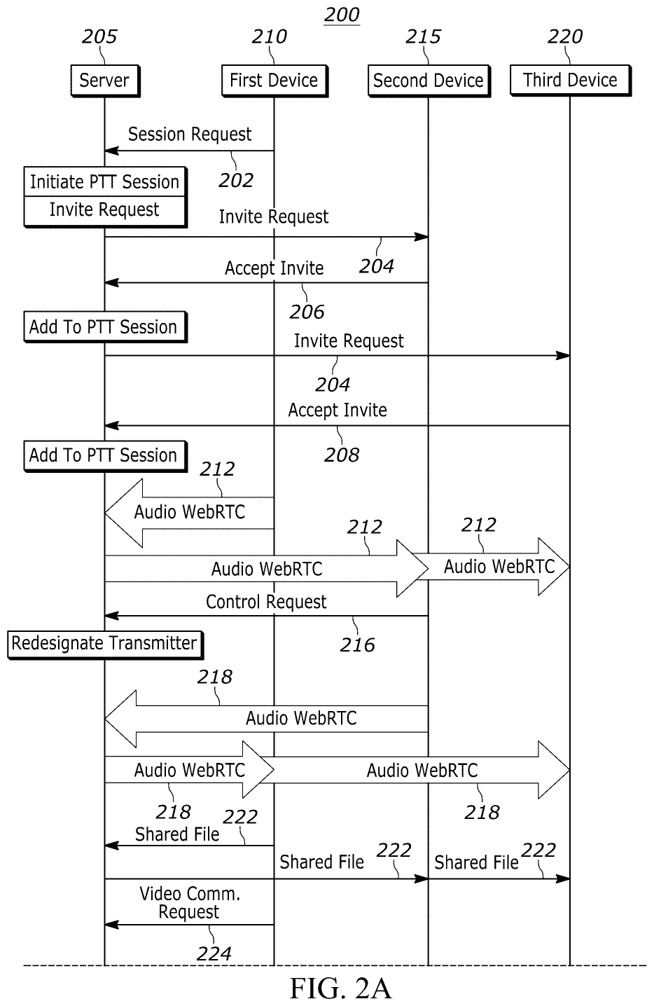

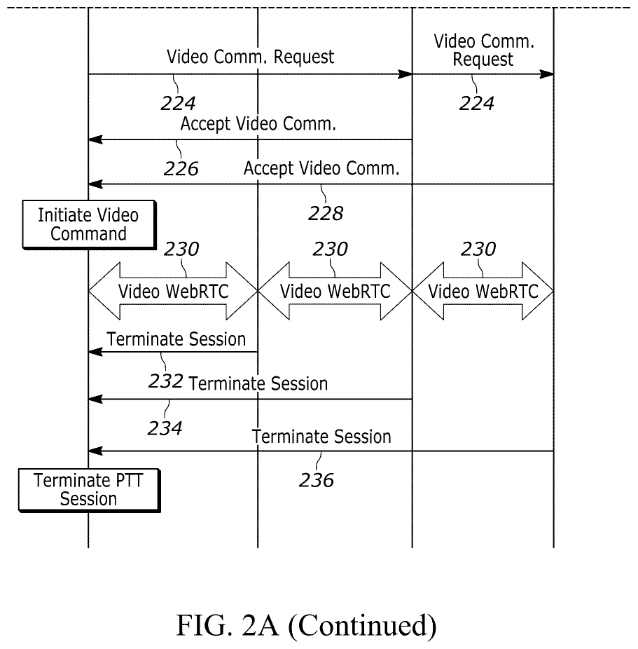

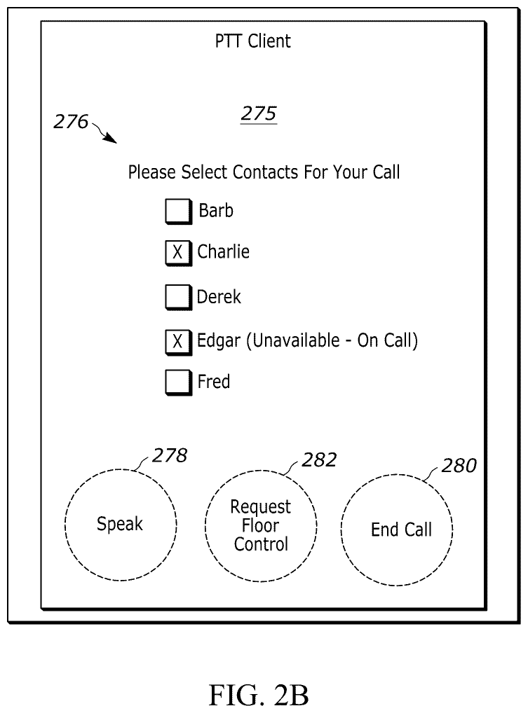

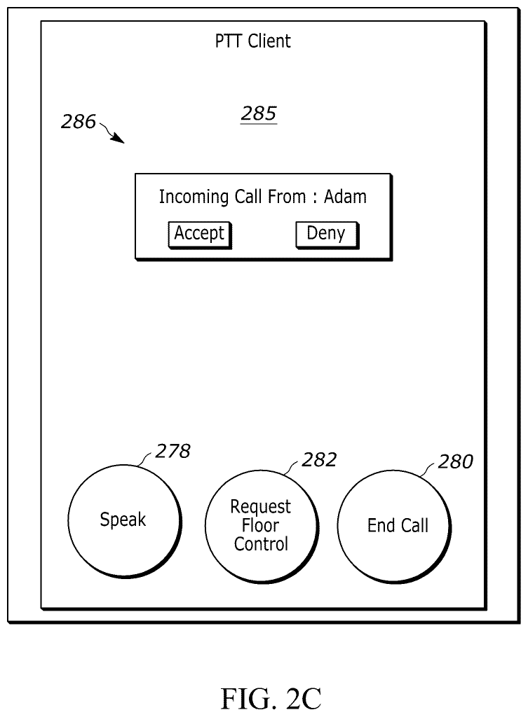

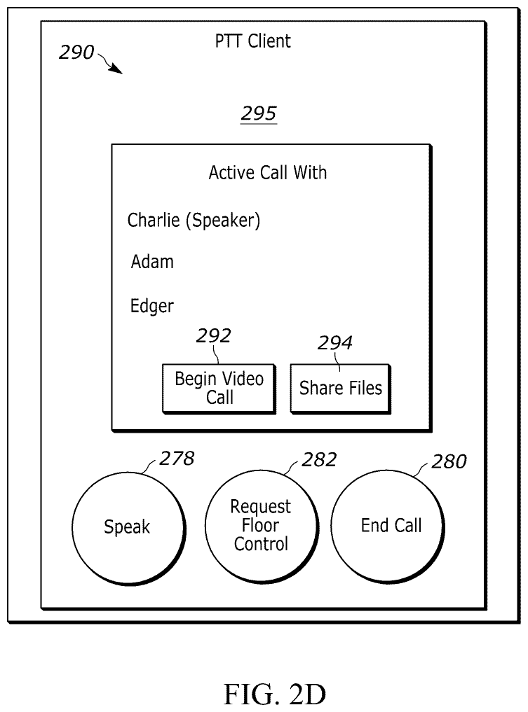

FIG. 2A depicts an example signal diagram 200 for providing a PTT session including half-duplex communications using WebRTC, according to some embodiments. It should be understood that the inputs and/or outputs depicted in the signal diagram 200 are for ease of illustration only, and may not represent and/or include every input/output and/or every component associated with the inputs/outputs. Moreover, a signal indicated in the signal diagram 200 as one signal may be comprised of multiple signals. For example, a session request including PTT session participant information may include a first signal to initiate the PTT session, and a second signal including PTT session participant information transmitted directly after the first signal.

The signal diagram 200 includes a server 205 (e.g., the server 105), a first user device 210, a second user device 215, and a third user device 220 (e.g., the user devices 115) participating in a PTT session. The PTT session may include user devices of other PTT session participants, and/or other suitable devices and/or components, such as those depicted in the computing environment 100.

To begin the PTT session, one of the user devices 210, 215, 220 may generate a session request (e.g. using the PTT client application 154) to initiate the PTT session, and transmit the session request to the server 205. In other embodiments, one of the user devices 210, 215, 220 may access the server 205 (e.g. via the network 110 using the PTT client application 154) to request initiation of the PTT session (e.g., via the server's PTT application 128). In such an embodiment, the server 205 may generate the session request and/or not require a session request to initiate the PTT session as requested, however any suitable manner may be used to initiate the PTT session.

FIG. 2B depicts a first example user interface (UI) 275 for initiating a PTT session including half-duplex communications using WebRTC, according to some embodiments. A user, Adam, associated with the first user device 210 would like to start a PTT session with some of his contacts. Adam may execute the PTT client application 154 on the first user device 210. The PTT client application 154 may generate the UI 275 on the display of the first user device 210 that includes a list of contacts 276 for Adam to select to join the PTT session. Adam selects the contact for Charlie, who is the user associated with the second user device 215, and Edgar, who is the user associated with the third user device 220, from the list of contacts 276. Adam's first user device 210 generates a session request including information for Charlie and Edgar (e.g., user name, user identification, device identification, etc.), and transmits (e.g., via the network 110) the session request to the server 205.

In at least some embodiments, the additional PTT session participants indicated in the session request 202 may be unavailable, as illustrated in the list of contacts 276 indicating that Edgar is unavailable. In one example, the PTT session participant may be unavailable due to being on another session. In another example, the PTT participant may have their device set to “do not disturb” or a similar setting, causing the associated user to be unavailable for a session. In instances where a potential PTT session participant is unavailable, the server 205 may refrain from transmitting the invite request 204 to the unavailable PTT session participant's user device, may transmit the invite request 204 to the unavailable PTT session participant's user device once the unavailable PTT session participant becomes available, may cause an alert to be displayed on the user device of the unavailable PTT session participant informing them they are invited to another session (e.g., so they may end their current session to join the session associated with the notification), may cause an alert to be displayed on the user device of the PTT session participant inviting the unavailable PTT session participant to join the session, and/or perform any other suitable action. In at least some embodiments, the server 205 may terminate the PTT session when a PTT session participant is unavailable, for example when the only additional PTT session participant indicated in the session request 202 is unavailable to join the PTT session.

Returning to FIG. 2A, the signal diagram 200 illustrates the first user device 210 transmitting the session request 202 to the server 205. In response to the session request 202, the server 205 initiates the PTT session including Adam as the initial PTT session participant designated as the transmitter. Moreover, the server 205 may generate an invite request 204, and transmit the invite request 204 to the second user device 215 of Charlie. As Edgar is unavailable, the server 205 refrains from sending the invite request 204 to Edgar's third user device 220. Responsive to receiving the invite request 204, the second user device 215 of Charlie may display a notification indicating the invite request 204. Charlie may choose to accept the invite request 204, in which his second user device 215 may generate a response 206 indicating acceptance of the invite, and transmit the response 206 to the server 205. In at least some embodiments, the server 205 may generate and transmit the invite request 204 to the additional PTT session participants indicated in the session request 202, and in response to a first additional PTT session participant accepting the request, initiate the PTT session including the session initiator and the acceptor of the invite request as PTT session participants. Said another way, the server 205 may refrain from initiating the PTT session until at least one additional PTT session participant indicates they will join the PTT call.

FIG. 2C depicts a second example user interface (UI) 285 for accepting the PTT session invite request 204 to join a PTT session, according to some embodiments. The UI 285 of Charlie's second user device 215 displays a notification 286 (e.g., generated by the PTT client application 154) indicating Charlie is receiving a call from Adam. The notification 286 allows Charlie to accept or deny the call. Responsive to Charlie accepting the call, the second user device 215 generates a response 206 accepting the invite request 204, and transmits the response 206 to the server 205. In response, the server 205 adds Charlie to the PTT session as a receiver of Adam's communications, unable to transmit communications to other PTT session participants according to the half-duplex protocol of the PTT session.

Shortly after Charlie joins the PTT session, Edgar ends the existing session in which he is participating. In response to Edgar becoming available, the server 205 transmits the invite request 204 to Edgar's third user device 220. A notification similar to the notification 286 appears on Edgar's third user device 220 informing Edger he is invited to the session by Adam. Via a UI on the third user device 220 similar to the UI 285, Edgar accepts the invite request 204, and in response the third user device 220 generates and transmits to the server 205 a response 208 accepting the invite request 204. In response to the response 208, the server 205 adds Edgar to the PTT session as a receiver of Adam's communications, unable to transmit communications to other PTT session participants (e.g. Charlie). In at least some embodiments, one or more of the requests (e.g., session request 202), responses (e.g., accept invite response 206), and/or otherwise transmissions between the server 205 and the user devices 210, 215, 220 may use a Websocket protocol for transmission.

While designated as the transmitter in control of the floor of the PTT session, Adam may transmit audio communications to all other PTT session participants via the first user device 210. For example, Adam may activate the virtual “speak” button 278 depicted in UI 275 and 285 that is provided by the PTT client application 154 of the first user device 210 while speaking. In response, the first user device 210 may capture and transmit Adam's speech as audio communications, however, Adam may transmit communications via the first user device 210 in any suitable manner (e.g., via a physical button on his first user device 210 having functionality similar to the virtual speak button 278). In at least some embodiments, the virtual speak button 278 may be nonfunctional (e.g., as indicated by the dotted lines depicting the virtual speak button 278 in the UI 275) or not present in the UI for a PTT session participant unless the PTT session participant is included in an active PTT session as a session participant, and/or unless the PTT session participant is designated as the transmitter of the PTT session.

Returning to FIG. 2A, Adam's first user device 210 transmits the audio communications 212 to the server 205 using WebRTC. The server 205 receives the audio communications 212, and transmits the audio communications 212 using WebRTC to the second user device 215 and third user device 220, as well as to the user devices of any other PTT session participants. In at least some aspects, the audio communications 212 use WebRTC including SRTP (e.g., for security and/or encryption of the audio communications 212). In at least some embodiments, a user device transmitting communications, such as the first user device 210 transmitting the audio communications 212, may transmit the communications to other user devices (e.g., device to device communications) without transmitting the communications to the server 205 and/or without needing the server 205 to relay the communications to the remining PTT session participants.

During the PTT session, Adam may no longer be designated as the transmitter. In one example, Adam may leave the PTT session while designated as transmitter using the virtual “end call” button 280 depicted in FIGS. 2B and 2C, which may provide the opportunity for another PTT session participant to take control of the floor as the transmitter. In another example, the PTT session may be configured with a timeout period, and if Adam as the transmitter does not transmit any communications during the timeout period, upon expiration of the timeout period, Adam may lose his designation as the transmitter (e.g., be redesignated by the server 205 as the receiver). In yet another example, the PTT client application 154 may provide a function to relinquish the designation as the transmitter. In still yet another example, a PTT session participant designated as a receiver such as Charlie or Edgar may request control of the floor from the transmitter using the virtual “request floor control” button 282 depicted in FIGS. 2B and 2C. If the floor control request is approved (e.g., by the server 205, by the current transmitter), the current transmitter may be redesignated as a receiver, and the receiver associated with the floor control request may be designated as the new transmitter.

In at least some embodiments, the virtual end call button 280 may be nonfunctional (e.g., as indicated by the dotted lines depicting the virtual end call button 280 in the UI 275) or not present in the UI for a PTT session participant unless the PTT session participant is included in an active PTT session as a session participant. In at least some embodiments, the virtual request floor control button 282 may be nonfunctional (e.g., as indicated by the dotted lines depicting the virtual request floor control button 282 in the UI 275) or not present in the UI for a PTT session participant unless the PTT session participant is included in an active PTT session as a participant and also designated as a receiver of communications.

The signal diagram 200 illustrates an example where Charlie requests control of the floor while Adam is designated as the transmitter via the virtual request floor control button 282 on his second user device 215. In response to Charlie activating the virtual request floor control button 282, his second user device 215 generates a floor control request 216, and transmits the floor control request 216 to the server 205. In response to accepting the floor control request 216, the server 205 redesignates the transmitter role of the PTT session by redesignating Adam from being the transmitter to being a receiver, and also redesignating Charlie from being a receiver to being the transmitter. Accordingly, Charlie now has control of the floor and is able to capture and transmit audio communications 218 (e.g., via the virtual speak button 278) from his second user device 215 to the server 205 using WebRTC. The server 205 transmits the audio communications 218 to the user devices of other PTT session participants on the call designated as receivers, including Adam's first user device 210 and Edgar's third user device 220.

The server 205 and/or other suitable device and/or component may terminate the PTT session. In one example, the server 205 may terminate the PTT session upon the expiration of a timeout period during which the transmitter does not provide communications, as previously described. In another example, the server 205 may terminate the PTT session when all PTT session participants leave the PTT session (e.g., via the virtual end call button 280).

In at least some embodiments, the PTT session may support full-duplex video communications and/or file sharing. Full-duplex video communication during the PTT session may include any PTT session participant being able to transmit and receive video simultaneously with any other PTT session participants using the WebRTC protocol. The video communications may include real-time video communications. Similarly, file sharing during the PTT session may include any PTT session participants being able to share files with any other PTT session participants using the WebRTC protocol.

In at least some embodiments, the communication environment providing the PTT session (e.g. computing environment 100) may include a first server (e.g., server 105, 205) for managing the PTT session participants, including initiating the PTT session, inviting potential PTT session participants to join the PTT session, designating transmitter or receiver roles to PTT session participants, and the like. In some such embodiments, the communication environment may further include a second server (e.g., server 105, 205) for managing the communications, including receiving and transmitting audio communications, video communications, and/or shared files among the PTT session participants.

FIG. 2D depicts a third example user interface (UI) 295 during the PTT session, according to some embodiments. The UI 295 includes an active call window 290. The active call window 290 displays the PTT session participants Chalie, Adam, and Edgar, and indicates that Charlie is presently designated as the speaker and transmitter of communications having control of the floor. The active call window 290 includes a virtual “begin video conference” button 292 that, when activated, may initiate a full-duplex video conference (e.g., including the current PTT session participants, to start a new video conference with other participants, etc.). The active call window 290 includes a virtual “share files” button 294 that, when activated, may allow the user activating the virtual share files button 294 to share files with one or more participants in the PTT session. Moreover, as the user of the user device displaying UI 295 is a participant in an active PTT call, the virtual speak button 278, the virtual request floor control button 282, and/or the virtual end call button 280 may all be displayed and/or functional in the UI 295.

Returning to the example of FIG. 2A, Adam activates the virtual share files button 294 on his first user device 210, to share files with Charlie and Edgar. In response to Adam activating the virtual share files button 294, Adam is able to select a file stored on his first user device 210 for sharing. In at least some embodiments, Adam may also be able to select PTT session participants to share the file with, such as Charlie and/or Edgar. The first user device 210 generates a shared file transmission 222 including the shared file, and transmits the shared file transmission 222 to the server 205. In response to receiving the shared file transmission 222, the server 205 may transmit the shared file transmission 222 to Charlie's second user device 215 and Edgar's third user device 220. The user devices 215, 220 may each generate a notification (e.g., the notification 286) for the respective users Charlie and Edgar to accept the shared file or reject the shared file of the shared file transmission 222.

Subsequent to sharing the file, Adam activates the virtual begin video conference button 292 via his first user device 210, for example to discuss the shared file with Charlie and Edgar using full-duplex video communications. In response to activating the virtual begin video conference button 292, Adam's first user device 210 generates a video communication request 224, and transmits the video communication request 224 to the server 205. The video communication request 224 may be a request to allow PTT session participants to receive and/or transmit video communications to other PTT participants. In response to receiving the video communication request 224, the server 205 may transmit the video communication request 224 to Charlie's second user device 215 and Edgar's third user device 220. Upon receiving the video communication request 224, a notification similar to the notification 286 may appear on the respective displays of Charlie's second user device 215 and Edgar's third user device 220, allowing them each to approve or reject transmitting video communications to other PTT session participants. For example, Charlie may be participating in the PTT session while driving his car and may not want to approve the video communication request 224 to keep his focus on the road while driving, but is otherwise able to participate in the PTT session via audio communications which does not distract him from driving. Upon accepting the video communication request, Charlie's second user device 215 may generate and transmit an accept video communications response 226 to the server 205, and Edgar's third user device 220 may generate and transmit an accept video communications response 228 to the server 205. The server 205 may then permit full-duplex video communications 230 using WebRTC between the participants Adam, Charlie, and Edgar.

In at least some embodiments, the computing environment (e.g., the computing environment 100) providing the PTT session may not require requests and/or approvals of the video communications 230, but rather automatically allows video communications between PTT session participants, in which case signals 224, 226, 228 may not be required to establish full-duplex video communications.

In at least some embodiments, the video communications 230 may be transmitted from a user device of a PTT session participant to the server 205, and the server 205 may relay the video communications 230 to the other PTT session participants. In some embodiments, the user devices of the PTT session may transmit the video communications 230 to the user devices of the other PTT session participants without transmitting the video communications 230 to the server 205 (e.g., device to device transmissions).

Adam, Charlie, and Edgar may be done conversing, and each activate the virtual end call button 280 on their respective user devices 210, 215 and 220 to leave the PTT session. The first user device 210, the second user device 215, and the third user device 220 may generate and transmit respective terminate session transmissions 232, 234, 236 to the server 205 in response to the respective users Adam, Charlie, and Edgar activating the virtual end call button 280. In response to receiving the terminate session transmissions 236, the server 205 may terminate the PTT session as no other PTT session participants remain in the PTT session.

Although FIGS. 2B-2D depict example UIs 275, 285, 295, it should be appreciated that the server 205 (e.g., via the PTT application 128) and/or user device (e.g., via the PTT client application 154) may generate other configurations of UIs according to the disclosed techniques. Further, while certain devices and/or components are depicted in the FIGS. 2A-2D as providing certain functionalities, it should be understood that additional, fewer, and/or alternate components may be configured to perform additional, fewer, or alternate functionalities. For example, one of the user devices 210, 215, 220 may be configured to manage file sharing instead of, or in addition to, the server 205.

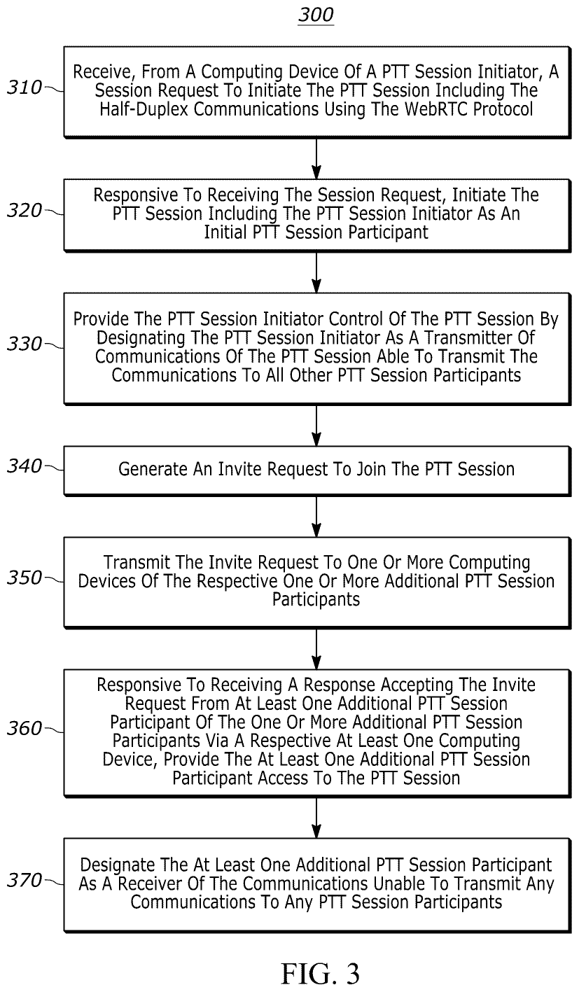

FIG. 3 depicts a flow diagram of an example method 300 for providing a PTT session including half-duplex communications using a WebRTC protocol. The method 300 may be performed, for example, by the example computing environment 100, and/or cause devices to generate, transmit, and/or receive signals such as those of the example signal diagram 200. The method 300 may include receiving, from a computing device of a PTT session initiator, a session request (e.g., the session request 202) to initiate the PTT session including the half-duplex communications using the WebRTC protocol (block 310). The session request includes information of one or more additional PTT session participants. In at least some embodiments, the WebRTC protocol may include Secure Real-Time Transport.

The method 300 may include, responsive to receiving the session request, (i) initiating the PTT session including the PTT session initiator as an initial PTT session participant (block 320); (ii) providing the PTT session initiator control of the PTT session by designating the PTT session initiator as a transmitter of communications of the PTT session able to transmit the communications to all other PTT session participants (block 330); generating an invite request (e.g., the invite request 204) to join the PTT session (block 340); and transmitting the invite request to one or more computing devices (e.g., the user device 115, 210, 215, 220) of the respective one or more additional PTT session participants (block 350). One or more of a request or a response associated with the PTT session may be transmitted using a Websocket protocol. The communications may include audio communications (e.g., the audio communications 212, 218).

The method 300 may include, responsive to receiving a response accepting the invite request (e.g., accept invite responses 206, 208) from at least one additional PTT session participant of the one or more additional PTT session participants via a respective at least one computing device, providing the at least one additional PTT session participant access to the PTT session (block 360), and designating the at least one additional PTT session participant as a receiver of the communications unable to transmit any communications to any PTT session participants (block 370).

It at least some embodiments, the method 300 may include (i) receiving, from the computing device of a PTT session participant of a plurality of PTT session participants of the PTT session, a control request (e.g., the control request 216) to provide the PTT session participant associated with the control request control of the PTT session by designating the PTT session participant associated with the control request as the transmitter of communications of the PTT session, and designating remaining PTT session participants as receivers of the communications unable to transmit any communications to any PTT session participants; (ii) approving the control request when the PTT session does not include the transmitter of the communications when the control request is received; and (iii) denying the control request when the PTT session includes the transmitter of communications when the control request is received.

It at least some embodiments, the method 300 may include determining the at least one additional PTT session participant is unavailable to join the PTT session, and responsive to determining the at least one additional PTT session participant is unavailable, one or more of: (i) refraining from transmitting the invite request to the at least one computing device of the respective at least one additional PTT session participant, (ii) transmitting the invite request to the at least one computing device of the respective at least one additional PTT session participant responsive to determining the at least one additional PTT session participant becomes available to join the PTT session, (iii) providing a notification to the computing device of the PTT session initiator indicating the at least one additional PTT session participant is unavailable, or (iv) terminating the PTT session.

It at least some embodiments of the method 300, PTT session may further include one or more of full-duplex video communications (e.g., the video communications 230) or file sharing (e.g., the shared file of shared file transmission 222).

It at least some embodiments, the method 300 may include terminating the PTT session based upon expiration of a timeout period during which the transmitter does not provide the communications, and/or all PTT session participants leaving the PTT session.

It should be understood that not all blocks of the flow diagram of FIG. 3 are required to be performed.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for providing a push-to-talk (PTT) session including half-duplex communications using a Web Real-Time Communication (WebRTC) protocol, the method comprising:
receiving, from a computing device of a PTT session initiator, a session request to initiate the PTT session including the half-duplex communications using the WebRTC protocol, wherein the session request includes information of one or more additional PTT session participants;
responsive to receiving the session request,
initiating the PTT session including the PTT session initiator as an initial PTT session participant,
providing the PTT session initiator control of the PTT session by designating the PTT session initiator as a transmitter of communications of the PTT session able to transmit the communications to all other PTT session participants,
generating an invite request to join the PTT session, and
transmitting the invite request to one or more computing devices of the respective one or more additional PTT session participants; and
responsive to receiving a response accepting the invite request from at least one additional PTT session participant of the one or more additional PTT session participants via a respective at least one computing device,
providing the at least one additional PTT session participant access to the PTT session, and
designating the at least one additional PTT session participant as a receiver of the communications unable to transmit any communications to any PTT session participants.

2. The method of claim 1, further comprising:
receiving, from the computing device of a PTT session participant of a plurality of PTT session participants of the PTT session, a control request to provide the PTT session participant associated with the control request control of the PTT session by designating the PTT session participant associated with the control request as the transmitter of communications of the PTT session, and designating remaining PTT session participants as receivers of the communications unable to transmit any communications to any PTT session participants;
approving the control request when the PTT session does not include the transmitter of the communications when the control request is received; and
denying the control request when the PTT session includes the transmitter of communications when the control request is received.

3. The method of claim 1, wherein one or more of a request or a response associated with the PTT session is transmitted using a Websocket protocol.

4. The method of claim 1, wherein the WebRTC protocol includes Secure Real-time Transport.

5. The method of claim 1, wherein the communications include audio.

6. The method of claim 1, further comprising:
determining the at least one additional PTT session participant is unavailable to join the PTT session; and
responsive to determining the at least one additional PTT session participant is unavailable, one or more of:
refraining from transmitting the invite request to the at least one computing device of the respective at least one additional PTT session participant,
transmitting the invite request to the at least one computing device of the respective at least one additional PTT session participant responsive to determining the at least one additional PTT session participant becomes available to join the PTT session,
providing a notification to the computing device of the PTT session initiator indicating the at least one additional PTT session participant is unavailable, or
terminating the PTT session.

7. The method of claim 1, further comprising:
designating the transmitter of the communications as a receiver of the communications based upon one or more of:
expiration of a timeout period during which the transmitter does not provide the communications,
receiving a relinquish request from the computing device of the transmitter to relinquish a designation as the transmitter; or
receiving the control request to control the PTT session from the computing device of a receiver of the communications of the PTT session.

8. The method of claim 1, wherein the PTT session further includes one or more of:
full-duplex video communications or file sharing.

9. The method of claim 1, further comprising terminating the PTT session based on one or more of:
expiration of a timeout period during which the transmitter does not provide the communications, or
all PTT session participants leaving the PTT session.

10. A system for providing a push-to-talk (PTT) session including half-duplex communications using a Web Real-Time Communication (WebRTC) protocol, the system comprising:
one or more processors; and
a memory storing instructions that, when executed by the one or more processors, causes the system to:
receive, from a computing device of a PTT session initiator, a session request to initiate the PTT session including the half-duplex communications using the WebRTC protocol, wherein the session request includes information of one or more additional PTT session participants;
responsive to receiving the session request,
initiate the PTT session including the PTT session initiator as an initial PTT session participant,
provide the PTT session initiator control of the PTT session by designating the PTT session initiator as a transmitter of communications of the PTT session able to transmit the communications to all other PTT session participants,
generate an invite request to join the PTT session, and
transmit the invite request to one or more computing devices of the respective one or more additional PTT session participants; and
responsive to receiving a response accepting the invite request from at least one additional PTT session participant of the one or more additional PTT session participants via a respective at least one computing device,
provide the at least one additional PTT session participant access to the PTT session, and
designate the at least one additional PTT session participant as a receiver of the communications unable to transmit any communications to any PTT session participants.

11. The system of claim 10, further comprising instructions that, when executed by the one or more processors, cause the system to:
receive, from the computing device of a PTT session participant of a plurality of PTT session participants of the PTT session, a control request to provide the PTT session participant associated with the control request control of the PTT session by designating the PTT session participant associated with the control request as the transmitter of communications of the PTT session, and designating remaining PTT session participants as receivers of the communications unable to transmit any communications to any PTT session participants;
approve the control request when the PTT session does not include the transmitter of the communications when the control request is received; and
deny the control request when the PTT session includes the transmitter of communications when the control request is received.

12. The system of claim 10, wherein one or more of a request or a response associated with the PTT session is transmitted using a Websocket protocol.

13. The system of claim 10, wherein the WebRTC protocol includes Secure Real-time Transport.

14. The system of claim 10, wherein the communications include audio.

15. The system of claim 10, further comprising instructions that, when executed by the one or more processors, cause the system to:
determine the at least one additional PTT session participant is unavailable to join the PTT session; and
responsive to determining the at least one additional PTT session participant is unavailable, one or more of:
refrain from transmitting the invite request to the at least one computing device of the respective at least one additional PTT session participant,
transmit the invite request to the at least one computing device of the respective at least one additional PTT session participant responsive to determining the at least one additional PTT session participant becomes available to join the PTT session,
provide a notification to the computing device of the PTT session initiator indicating the at least one additional PTT session participant is unavailable, or
terminate the PTT session.

16. The system of claim 10, further comprising instructions that, when executed by the one or more processors, cause the system to:
designate the transmitter of the communications as a receiver of the communications based upon one or more of:
expiration of a timeout period during which the transmitter does not provide the communications,
receiving a relinquish request from the computing device of the transmitter to relinquish a designation as the transmitter; or
receiving the control request to control the PTT session from the computing device of a receiver of the communications of the PTT session.

17. The system of claim 10, wherein the PTT session further includes one or more of:
full-duplex video communications or file sharing.

18. The system of claim 10, further comprising instructions that, when executed by the one or more processors, cause the system to terminate the PTT session based on one or more of:
expiration of a timeout period during which the transmitter does not provide the communications, or
all PTT session participants leaving the PTT session.

19. A tangible machine-readable medium comprising instructions that, when executed by one or more processors, cause a machine to at least:
receive, from a computing device of a push-to-talk (PTT) session initiator, a session request to initiate a PTT session including half-duplex communications using a Web Real-Time Communication (WebRTC) protocol, wherein the session request includes information of one or more additional PTT session participants;
responsive to receiving the session request,
initiate the PTT session including the PTT session initiator as an initial PTT session participant,
provide the PTT session initiator control of the PTT session by designating the PTT session initiator as a transmitter of communications of the PTT session able to transmit the communications to all other PTT session participants,
generate an invite request to join the PTT session, and
transmit the invite request to one or more computing devices of the respective one or more additional PTT session participants; and
responsive to receiving a response accepting the invite request from at least one additional PTT session participant of the one or more additional PTT session participants via a respective at least one computing device,
provide the at least one additional PTT session participant access to the PTT session, and
designate the at least one additional PTT session participant as a receiver of the communications unable to transmit any communications to any PTT session participants.

20. The tangible machine-readable medium of claim 19, further comprising instructions that, when executed by the one or more processors, cause the machine to at least:
receive, from the computing device of a PTT session participant of a plurality of PTT session participants of the PTT session, a control request to provide the PTT session participant associated with the control request control of the PTT session by designating the PTT session participant associated with the control request as the transmitter of communications, and designating remaining PTT session participants as receivers of the communications unable to transmit any communications to any PTT session participants;
approve the control request when the PTT session does not include the transmitter of the communications when the control request is received; and
deny the control request when the PTT session includes the transmitter of communications when the control request is received.
